(19) United States
(12) Patent Application Publication
(10) Pub. No.: US 2016/0256805 A1
(43) Pub. Date: Sep. 8, 2016

(54) Filter Medium, Method for Producing a Filter Medium and a Filter Element Having a Filter Medium

(71) Applicant: Mann+Hummel GMBH, Ludwigsburg (DE)

(72) Inventors: Thomas Grein, Eggenstein-Leopoldshafen (DE); Joachim Stinzendoerfer, Speyer (DE); Anton Kreiner, Reisbach (DE)

(21) Appl. No.: 15/058,463

(22) Filed: Mar. 2, 2016

(30) Foreign Application Priority Data
Mar. 3, 2015 (DE) 102015002672.0

(51) Int. Cl. B01D 39/16; B01D 29/00; D01D 5/00; C02F 1/00

(52) U.S. Cl. CPC B01D 39/163; C02F 1/001; B01D 29/0093; D01D 5/0007; C02F 2201/002; D10B 2505/04

(57) ABSTRACT

A filter medium for filtering a fluid, the filter medium including: a first media ply; and a second media ply; wherein said second media ply is positioned downstream of the first media ply in an intended flow direction of the filter medium; and wherein said first media ply is formed as a nanofiber ply with nano-fibers; and wherein said second media ply is formed as a support layer with an average surface weight of more than 60 g/m2; wherein the first media ply has a first region on an inflow side and a second region on an outflow side in a direction of the second media ply; wherein the nanofibers of the first region have a smaller average fiber diameter than the nanofibers of the second region.

### TECHNICAL FIELD

The invention relates to a filter medium for filtering fluids, in particular for filtering liquids, as well as a filter element having such a filter medium and a method for producing such a filter medium, in particular for use as an erosion filter.

### BACKGROUND OF THE INVENTION

It is known to arrange nanofibers on a considerably coarser support ply. The application of fine fibers onto a support ply is used for stabilizing the fine fiber layer during the filtration process, but also during processing, in particular during folding of the nanofibers.

A layered design is also used when matching media to the requirements of depth filtration. In such media, coarser fibers are as a rule followed in the flow direction by finer fibers. As a result, a fractional separation of the particles in the depth of the medium is intended to be achieved. The objective is here a loading as regular as possible of the filter medium and thus an optimal utilisation of the pore volume in the filter medium that is available for the embedding of the particles. For example, EP 2 222 385 A2 discloses a nanofiber ply with a gradient in respect of the fiber diameter. However, this diameter decreases in the flow direction.

Moreover, erosion filter elements with filter media from nonwoven fiber are already known from EP 1 764 144 A1, to which reference is made in respect of the design of an erosion filter within the scope of the present invention. The design of the filter medium used includes a nanofiber ply that is applied to a cellulose support layer.

### SUMMARY OF THE INVENTION

It is the object of the present invention to provide, on the basis of EP 1 764 144 A1, a foldable filter medium having at least one nanofiber ply that has improved resistance.

The above-mentioned object is achieved by means of a filter medium according to the invention having the features of claim 1.

A filter medium according to the invention includes a first media ply and a second media ply, with the second media ply being provided downstream of the first media ply in an intended flow direction of the filter medium and the first media ply being formed as a nanofiber ply with nanofibers and the second media ply being formed as a support layer having an average surface weight of more than 60 g/m².

On the inflow side, the first media ply of the filter medium according to the invention has a first region and on the outflow side towards the second media ply, a second region.

The nanofibers of the first region have a smaller average fiber diameter than the nanofibers of the second region.

The filter medium according to the invention has, on the one hand, an excellent filtering effect with a comparatively low pressure loss and is, despite the use of very fine nanofibers, resistant against mechanical influences and chemically aggressive substances.

Advantageous embodiments of the invention are the subject matter of the dependent claims.

In order to achieve a particularly good filtering effect, it is expedient to use a particularly large number of nanofibers with smaller fiber diameters in the first region. It is therefore of advantage if more than 75% of the nanofibers of the first region have a smaller fiber diameter than the nanofibers of the second region.

From EP 2 398 633 A1, for example, filter media are known which are designed with multiple plies and which have nanofibers that are loosely arranged between the plies. However, these nanofibers may increasingly be mixed with each other after prolonged periods of use, so that the gradient structure of the nanofiber ply is gradually lost. It is therefore of advantage if the nanofibers of the first region are laid on top of the nanofibers of the second region, in particular by means of an electrospinning method. The nanofibers of the first region adhere, predominantly as a result of form interlocking and/or surface interactions, on the nanofibers of the second region. Preferably, additional adhesion of the nanofibers of both the first region and the second region may be achieved by using an adhesion promoter located on the second media ply. As a result, an advantageous additional adhesion reinforcement is achieved.

The first region may consist of nanofibers with an average fiber diameter of 50 to 400 nm, preferably of 50 to 250 nm, more preferably of 50 to 150 nm. These very fine nanofibers enable an optimal filtering behavior. The nanofibers of the first region are preferably produced using the electrospinning method.

The second region may consist of nanofibers with an average fiber diameter of 150 to 1000 nm, preferably of 150 to 500 nm, particularly preferably of 150 to 299 nm. These rather coarser nanofibers support the nanofibers of the first region, enhance the resistance of the fibers of the first region and contribute towards filtering the fluid to be filtered. Nanofibers of the second region are preferably produced using the electrospinning method. Compared to fiber composites produced using other production methods, for example compared to spun-bonded nonwoven materials, the electrospinning method may have advantages in that in particular smaller fiber diameters, a thinner design of effective layers and a smaller spread with regard to fiber diameters or pore sizes within the fiber ply can be made possible.

Particularly preferably, the nanofibers of the first and/or the second region are one-component nanofibers, which are lighter and can be processed into a filter medium such as, for example, bicomponent and/or split fibers with more uniform properties.

Particularly preferably, all the nanofibers of the first media ply are produced using the electrospinning method.

Particularly preferably, the nanofibers of the first and/or the second region are arranged on top of each other in the form of a spider's web. Further preferably, the nanofibers of the first and/or the second region have a substantially circular cross section. This allows in particular more uniform properties to be achieved, since a modification to the position of an individual fiber, in particular a rotation, does not lead to a significant change to the cross section of the individual fiber transversely to the flow direction.

Preferably, more than 75% of the nanofibers of the first material ply may consist of polyamide nanofibers, in particular 100% of polyamide. Nanofibers made from polyamide can be produced in a time-efficient and cost-effective manner.

The first material ply preferably has a surface weight of less than 20 g/m², preferably less than 10 g/m², particularly preferably less than 1 g/m². Thus, for example, a high separation performance at the same time with a pressure loss as low as possible, sufficient overall stability and low material costs is achieved.

Further preferred nanofiber materials according to the present invention or materials that can be spun into nanofibers according to the present invention, are polyolefins, polyacetals, polyesters, cellulose esters, cellulose ethers, polyalkylene sulfides, polyarylene oxides, polysulfones and/or mixtures of these polymers. Particularly preferred materials of the above-mentioned polymer classes that may be used for the abovementioned nanofibers are in particular polyethylene, polypropylene, polyvinyl chloride, polymethyl methacrylate (and further acrylic resins), polystyrene and/or copolymers of the above-mentioned polymers, including block copolymers of the ABBA type, as well as polyvinylidene fluoride, polyvinylidene chloride, polyvinyl alcohol in various hydrolysis degrees (87% to 99.5%) in a crosslinked or a non-crosslinked form.

The average fiber diameter of the nanofibers increases from the first to the second region at least by a factor of 1.5 to 5.0; however preferably by a factor of at least 1.5 to 3.0. This relates to the overall number of fibers in the first and second regions. Of course, individual fibers in the first region may also be thinner than in the second region.

On average over all the fibers located in the first region, however, the fiber diameter increases by the above-mentioned factor compared to all the fibers located in the second region.

The second material ply, i.e. the support ply, may advantageously be formed as a meltblown or spun-bonded ply or as a meltblown or spun nonwoven ply. Nonwoven fiber has proven to be useful for filtering fluids, in particular liquids. In this context, at least 50%, in particular at least 75% of the fibers of the second material ply may consist of a polyester and/or of a polypropylene. Alternatively, the second material ply may be formed as a cellulose-based ply.

The second material ply ideally consists of particularly resistant fibers. Therefore, the fibers of this material ply may advantageously have an average fiber diameter of more than 3 μm.

A filter element according to the invention has a filter medium according to the invention, wherein the filter medium of the filter element is folded.

This may particularly preferably be formed from a circular body, and the filter element may have two end caps, between which the circular body formed from the filter medium is located, in particular surrounded. Of course, the filter element may also have further components, e.g. a cylindrical support body as a moulded body from plastic or from metal.

Particularly preferably, the circular body may be formed to be star-shaped. Alternatively, the circular body may be formed in the shape according to DE 10 2009 057 438 B3, to the disclosure of which reference is made in its entirety with regard to the shape and the design of a filter element within the scope of the present invention.

The filter element may in particular be formed as a filter cartridge and may be used for filtering liquids, for example, water, oil or fuel.

A particular use of the filter element is its use as an erosion filter in an erosion machine.

Within the context of the use as an erosion filter, the average fiber diameter of the respective regions of the first material ply may be matched to the particle spectrum of the medium to be filtered. As a result, an optimal filter cake is formed that prevents blocking of the underlying fibers. In this context the filter element, if it is used as an erosion filter according to the invention, also has to withstand higher mechanical loads than in the case of air filters.

Apart from that, the first material ply may also have more than two regions with nanofibers. In this case, the average fiber diameter of the nanofibers of the regions preferably increases from the inflow side to the second material ply from one region to another.

The invention further relates to a method for producing a filter medium, in particular a filter medium for liquid filtration, which medium includes a first media ply and a second media ply, which second media ply can be arranged in particular downstream of the first media ply in an intended flow direction of the filter medium, which first media ply is formed as a nanofiber ply with nanofibers and which second media ply is formed as a support layer with an average surface weight of more than 60 g/m², wherein the support layer is provided and the nanofiber layer is applied onto the support layer with at least one first region and one second region, which first region is orientated towards the second media ply and the nanofibers of the first region have a smaller average fiber diameter than the nanofibers of the second region. In this context, the first and/or the second region of the nanofibers is/are preferably produced using the electrospinning method.

### BRIEF DESCRIPTION OF THE DRAWINGS

Further advantages will become evident from the following description of the drawings. The drawings illustrate embodiment examples of the invention. The drawings, the description and the claims contain numerous features in combination. A person skilled in the art will expediently also look at the features individually and will combine them to form useful further combinations.

The following is shown by way of example:

FIG. 1 shows a schematic view of a filter medium having two material plies according to an embodiment example of the invention; and

FIG. 2a, 2b each show a schematic view of a preferred embodiment of a filter element as an erosion filter.

### DESCRIPTION OF THE INVENTION

The figures merely show examples and are not to be understood in a limiting sense.

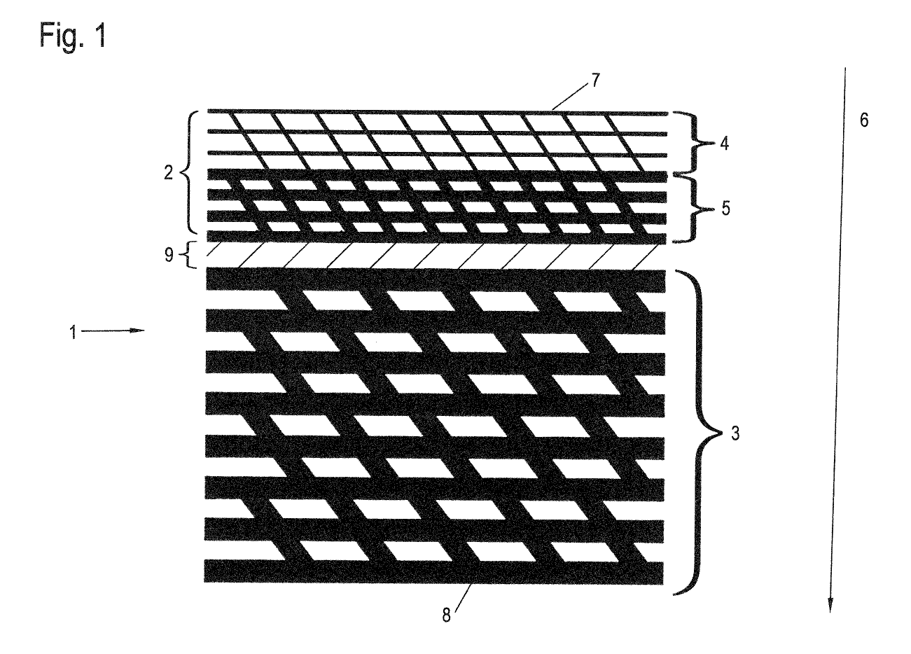

FIG. 1 shows an embodiment example of a filter medium 1 according to the invention. In the figure shown, this filter medium has two material plies 2 and 3, the first of the two material plies 2 being subdivided into a top and a bottom region 4, 5. The filter medium may be used for filtering a fluid. A preferred application is the use as a particle filter for cleaning liquids.

The term “filter medium” relates to a structure for filtering a fluid. In this context, a retentate as well as a filtrate, the cleaned fluid, are formed on or in the filter medium. Particularly preferably, particles as the retentate are filtered out of the fluid by the filter medium and are thus removed from the fluid. Depending on the implementation of the filter medium, particles and other substances may be removed from the fluid to be filtered either completely or just partially.

The filter medium may be provided as part of a filter element. The filter element could for example be a replaceable part in a machine or a plant. Such a replaceable part may e.g. be a filter cartridge. If a filter medium becomes clogged with retentate, the filter cartridge can be replaced, without the entire machine being affected by a replacement.

The two material plies 2 and 3 of the filter medium 1 are arranged on top of each other in the flow direction 6. On the inflow side 7 and/or the outflow side 8 of the two material plies 2 and 3 of the filter medium 1, further material plies may be provided.

A further material ply on the inflow and/or the outflow side 7, 8, may for example be a wide-meshed network structure that additionally holds the material plies 2 and 3 together. Other material plies are also conceivable.

A first material ply 2 is nonwoven nanofiber. The term “nanofibers” includes fibers with an average fiber diameter in the region between one nanometre and 1000 nanometres.

In a preferred design variant, more than 90% of the fibers forming the first material ply 2 are nanofibers. Particularly preferably, more than 95%, in particular 99%, of the fibers contained in the material ply are nanofibers.

The first material ply 2 is the material ply of the two material plies 2 and 3 that is provided on the inflow side 7. The first material ply 2 has nanofibers with different average fiber diameters. Whilst finer nanofibers, i.e. nanofibers with a lower average fiber diameter, are to be found in the region of the inflow side 7 of the material ply 2, coarser nanofibers, i.e. nanofibers with a larger average fiber diameter, can be found on the side of the material ply 2 that is connected with the second material ply 3.

At least in the upper 10% of the overall height of the first material ply 2, a first region 4 with fibers is provided, which consists of fine nanofibers with an average fiber diameter of 50 to 400 nm, preferably of 50 to 250 nm, more preferably of 50 to 150 nm.

At least in the lower 10% of the overall height of the first material ply 2, a second region 5 with fibers is provided, which consists of coarse nanofibers with an average fiber diameter of 150 to 1000 nm, preferably of 150 to 500 nm.

The fibers of the first region 4 have a smaller average fiber diameter than the fibers of the second region 5. The average fiber diameter may here be determined by means of an image section from the top. When doing so, the fiber diameters of all the fibers located in the image section may be determined and a mean value of these fiber diameters may be determined. Particularly preferably, the average fiber diameter may be detected using the method according to patent application DE 10 2009 043 273 A1, to which reference is made in its entirety within the scope of the present invention.

The nanofibers of the regions 4 and 5 may be produced using a meltblown or electrospinning method. To the producers of systems for producing ultrafine fibers by means of meltblown or electrospinning methods, the uniformity of the produced fibers is an essential quality criterion. The customer should be enabled to produce fibers in a reproducible manner with a substantially exactly defined diameter with a low spread. Thus, it is for example possible to produce nanofibers with the above-mentioned average fiber diameter in a defined manner and to arrange them on top of each other in plies. Thus, the first material ply 2 may also be formed in multiple plies with two or more sub-plies, which are arranged on top of each other, for example in a loose form, i.e. without an adhesive bond.

Alternatively, the nanofibers of the regions 4 and/or 5 may advantageously be realised by means of a wet laying process.

When arranging the sub-plies, a transitional region between the sub-plies may develop, in which both coarse and fine nanofibers are located. Thus, the material plies merge into each other between the regions 4 and 5.

The design of the first material ply 2 thus has a gradient design with regard to the fiber diameter, in which the average fiber diameter of the nanofibers increases in the flow direction 6. A gradient of the fiber diameter in terms of the present invention can mean both a regular increase, however preferably also an irregular, in particular stepwise increase of the fiber diameter in the flow direction 6. This increase in the average fiber diameter increases, in relation to the overall number of the nanofibers in the first and second regions 4 and 5, from the first to the second region by a factor of 1.5-5.0; preferably by a factor of 1.5-3.0.

The average surface weight of the first material ply 2 is here preferably less than 1 g/m².

The nanofibers of the first material ply 2 may be produced from different materials in the regions 4 and 5. However, in a particularly preferred embodiment variant of the invention, the nanofibers of the first material ply are all made from the same material. Particularly preferably, the nanofibers may be polyamide fibers.

Preferably, the nanofibers of the first material ply 2 may also all be produced using an electrospinning method, so that the entire nanofiber ply may be realised using this manufacturing process.

When laying the nanofibers of the first region, they adhere to the nanofibers of the second region as a result of form interlocking and/or surface interactions.

The connection of the first and second material plies 2 and 3 may be selected as desired. Thus, the first material ply 2 may in a preferred design variant merely be laid on top of the second material ply 3.

In an alternative preferred design variant, an adhesion promoter 9 is provided between the two material plies 2 and 3. In this variant, also an additional adhesion of the nanofibers of the first region 4 in addition to the nanofibers of the second region 5 may be achieved using the adhesion promoter 9 that is located on the second medium ply 3. As a result, advantageous additional adhesion reinforcement is achieved. As an adhesion promoter 9, a multiplicity of substances may be used. Preferred adhesion promoters may be based on acryl and/or polyurethane and may in particular be applied in the form of a dispersion. These adhesion promoters are particularly preferred because they dry at comparatively low temperatures.

The nanofibers of the first and second regions 4 and 5 are here preferably laid on top of each other in the form of a spider's web and may optionally be connected to the second material ply 3 by means of an adhesion promoter.

The second material ply 3 is a support ply made from nonwoven fiber. This may e.g. be formed as meltblown nonwoven fiber or as spun-bonded nonwoven fiber.

The average surface weight of the second material ply 3 may preferably be more than 60 g/m². The determination of the average surface weight is carried out according to DIN/EN ISO 536 for paper plies and according to DIN/EN 29073-1 for nonwoven material.

Thus, the average surface weight of the support ply is at least 60 times greater than the average surface weight of the nonwoven nanofiber.

The average fiber diameter of the fibers of the second material ply is more than 3 μm.

The fibers of the second material ply 3 may preferably be polyester and/or polypropylene fibers. Cellulose-based fibers may also preferably be used for the second material ply.

The filter medium according to the invention may be used for filtering both gases and liquids. However, the use of the filter medium as a particle filter during the filtration of liquids is particularly advantageous. In liquid filtration, particular requirements are placed on the stability of the filter media due to the higher flow forces involved compared to gas filtration. Therefore, an enhanced mechanical stability is particularly required. Thin fine-fiber supports, such as e.g. nanofiber networks, can by themselves withstand these flow forces only if they are present as a sufficiently thick layer. Since the pressure loss that occurs in the case of a fluid flowing through a fiber fill increases with the specific surface and the layer thickness of the fibers, thick and thus stable ultrafine fiber supports would experience an uneconomically high pressure loss. Therefore, nanofibers will in any case be stabilized by a carrier structure with comparatively coarse fibers.

The first media ply 2 may merely be laid on top of the second media ply 3. The two media may however also be bonded together or may be welded together at different points or along the edge, e.g. by ultrasonic welding.

Apart from the gradient design with regard to the fiber diameter, the design of the nanofiber ply may be matched to the requirements of the filtration application and the carrier material. For example, if the nanofiber ply is supported by a relatively open-pored spunbonded nonwoven material as the second material ply 3, the fiber layer in the lower region 5 of the nanofiber ply may be selected to be stronger than in the case of a meltblown nonwoven material as the carrier.

Based on experience, thick fibers are mechanically and chemically more resistant than thin fibers. A substantial difficulty during the manufacture of nanofiber media consists in ensuring sufficient stability of these fine fibers.

By positioning thicker nanofibers in the bottom region 5 of the nanofiber ply, an increased resistance of this media ply 2 may be achieved using an increased number of support points.

As a result of the gradient design in the nanofiber ply, the second media ply 3 may be selected to have comparatively coarse pores and therefore to be cost-effective. The coating of the carrier or support ply with a nanofiber support layer and the ultrafine fiber support may be carried out using electrospinning in a single process.

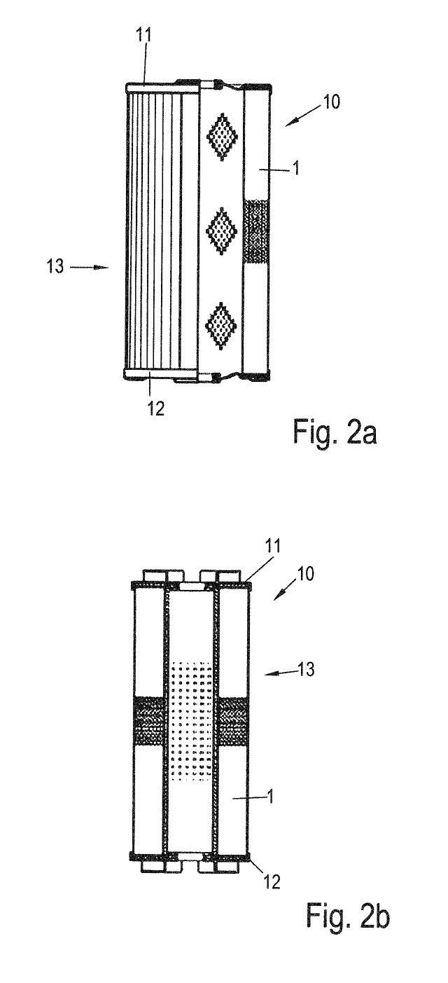

FIGS. 2a and 2b show various variants of a filter element 10 with a pleated filter medium 1 according to the embodiment example of FIG. 1. The filter medium 1 is here pleated in a star-shaped manner to form a circular body that is terminated at both ends with a first 11 and a second 12 end cap. These two end caps 11, 12 are used for receiving and fixing as well as sealing the filter element 10 in a housing of a filter system. On the outer circumference of the circular body of the filter medium 1, fold edges can be seen that run parallel to a longitudinal direction of the support layer of the filter medium 1, whereas a transverse direction of the support layer extends perpendicularly thereto. The flow direction 13 of a fluid through the filter element 10 is radially from the outside inwards into the circular body of the filter medium 1, from where the filtered fluid can then axially flow out of the filter element 10 through an outlet. In such an embodiment example, the filter element 10 may for example be used as an erosion filter in an erosion machine and may be used for removing particles from a liquid, in particular from water or an aqueous solution.

The employed mass of the employed polymer material per surface section for forming the nanofibers of the first region 4 of the first material ply 2 may preferably be 20% to 5000% of the mass of the employed polymer material for forming the nanofibers of the second region 5 of the first material ply 2.

What is claimed is:

1. A filter medium for filtering a fluid, the filter medium comprising:
a first media ply; and
a second media ply;
wherein said second media ply is positioned downstream of the first media ply in an intended flow direction of the filter medium; and
wherein said first media ply is formed as a nanofiber ply with nanofibers; and
wherein said second media ply is formed as a support layer with an average surface weight of more than 60 g/m2;
wherein the first media ply has a first region on an inflow side and a second region (5) on an outflow side in a direction of the second media ply;
wherein the nanofibers of the first region have a smaller average fiber diameter than the nanofibers of the second region.

2. The filter medium as claimed in claim 1, wherein
more than 75% of the nanofibers of the first region have a smaller fiber diameter than the nanofibers of the second region.

3. The filter medium as claimed in claim 1, wherein
nanofibers of the first region and/or the nanofibers of the second region are laid directly on top of each other, the fibers laid by electrospinning.

4. The filter medium as claimed in claim 1, wherein
the first region consists of nanofibers with an average fiber diameter of 50 to 400 nm.

5. The filter medium as claimed in claim 4, wherein
the first region consists of nanofibers with an average fiber diameter of 50 to 150 nm.

6. The filter medium according to claim 1, wherein
the second region consists of nanofibers with an average fiber diameter of 150 to 1000 nm.

7. The filter medium according to claim 6, wherein
the second region consists of nanofibers with an average fiber diameter of 150 to 299 nm.

8. The filter medium as claimed in claim 1, wherein
the average fiber diameter of the nanofibers, in relation to the overall number of fibers in the first and second regions, increases from the first to the second region by a factor of 1.5-5.0.

9. The filter medium as claimed in claim 1, wherein
more than 75% of the nanofibers of the first media ply are polyamide nanofibers.

10. The filter medium as claimed in claim 1, wherein
the first media ply has a surface weight of less than 20 g/m².

11. The filter medium as claimed in claim 10, wherein
the first media ply has a surface weight of less than less than 1 g/m².

12. The filter medium as claimed in claim 1, wherein
the second media ply is a meltblown ply or a spun-bonded ply.

13. The filter medium as claimed in claim 1, wherein
at least 50% of the fibers of the second media ply consist of a polyester and/or of a polypropylene.

14. The filter medium as claimed in claim 1, wherein
an average fiber diameter of the fibers of the second media ply is more than 3 μm.

15. A filter element having a filter medium as claimed in claim 1, wherein
the filter medium of the filter element is folded and formed into a circular body;
wherein the filter element has two end caps, between which the circular body formed from the filter medium is provided.

16. Use of the filter medium as claimed in claim 1 for filtering water, oil, fuel or for the dielectric of a spark erosion machine.

17. A method for producing a filter medium, the steps comprising:
providing a first media ply formed as a nanofiber ply with nanofibers and having a first region on an inflow side and a second region on an outflow side,
wherein the nanofibers of the first region have a smaller average fiber diameter than the nanofibers of the second region;
providing a support layer as a second media ply with an average surface weight of more than 60 g/m2;
applying the first media ply onto the support layer such that the second region is oriented towards the support layer;
wherein said second media ply is positioned downstream of the first media ply in an intended flow direction of the filter medium.

18. The method as claimed in claim 17, wherein in the strep of providing a first media ply, the first and/or the second region of the nanofibers is produced by electrospinning.
